(19) United States
(12) Patent Application Publication
(10) Pub. No.: US 2013/0250156 A1
(43) Pub. Date: Sep. 26, 2013

(54) IMAGE CAPTURING APPARATUS AND CONTROL METHOD THEREOF

(71) Applicant: CANON KABUSHIKI KAISHA, Tokyo (JP)

(72) Inventors: Makoto Kameyama, Yokohama-shi (JP); Koji Yoshida, Fujisawa-shi (JP)

(73) Assignee: CANON KABUSHIKI KAISHA, Tokyo (JP)

(21) Appl. No.: 13/788,187

(22) Filed: Mar. 7, 2013

(30) Foreign Application Priority Data
Mar. 22, 2012 (JP) 2012-066108
Feb. 18, 2013 (JP) 2013-029437

(51) Int. Cl. G06F 3/041

(52) U.S. Cl. CPC G06F 3/041
USPC 348/333.01

(57) ABSTRACT

An image capturing apparatus comprise an image capturing unit; a button; a touch detecting unit configured to detect a touch operation on a touch panel; and a control unit configured to control, when an operation of the button is accepted in a specific operation mode, the image capturing unit so that the image capturing unit performs shooting for a term that corresponds to a time period for which the operation is continued, and to control, in the specific operation mode, the image capturing unit so that the image capturing unit starts shooting in response to the touch operation on the touch panel, and ends the shooting when it is detected that the touch of the touch operation is released and another touch is performed.

### BACKGROUND OF THE INVENTION

1. Field of the Invention

The present invention relates to an image capturing apparatus and a control method of the image capturing apparatus, particularly relate to a shooting control technique for shooting with indefinite slow shutter speed.

2. Description of the Related Art

Recent image capturing apparatuses, such as digital cameras, are provided with a touch panel as a display device for displaying a through image, and through the operation of the touch panel, it is not only possible to configure settings of the camera but also to do the shooting by using the touch panel as a shutter switch. The shooting using the touch panel while displaying the through image has the characteristics that it is easy to designate and shoot an object, but makes it necessary for a user to firmly hold the camera, since a finger is used for the touch panel operation, than when shooting by operating the shutter switch. Accordingly, there are also cameras that can shoot using either a shutter switch or a touch panel.

On the other hand, there are TIME shooting and BULB shooting as methods for shooting with indefinite slow shutter speed. BULB shooting is a method in which a shutter switch is continuously turned on during shooting, and thus has the aspects that the camera is hardly shaken if it is firmly held, since less operation is required during exposure, but it requires a burdensome operation, since the shutter switch must be continuously turned on. TIME shooting is a method in which the start and the end of shooting are independently instructed, and thus has the aspects of being less burdensome than BULB shooting, since no operation is required during exposure, but the camera tends to be shaken, since more operations are required during shooting (see, for example, Japanese Patent Laid-Open No. 03-158839).

It is desirable to perform BULB shooting, with which the camera tends to be shaken less, when shooting with slow shutter speed of a shorter exposure time, and TIME shooting when shooting with slow shutter speed of a longer exposure time, that is, it is desirable to make it easy to switch between those two methods. Japanese Patent Laid-Open No. 03-158839 proposes a method for performing TIME shooting using a remote controller as an accessory. However, with this method, it is impossible to easily switch between BULB shooting and TIME shooting in accordance with a difference between the operation methods in the same operation mode without switching the operation mode.

### SUMMARY OF THE INVENTION

The present invention has been made in consideration of the aforementioned problems, and realizes an image capturing apparatus and a control method of the image capturing apparatus capable of easily switching, in accordance with a difference between the operation methods in the same operation mode without switching the operation mode, between a shooting such as BULB shooting that corresponds to an operation time period and a shooting such as TIME shooting in which the start and the end of shooting are independently instructed.

In order to solve the aforementioned problems, the present invention provides an image capturing apparatus comprising: an image capturing unit; a button; a touch detecting unit configured to detect a touch operation on a touch panel; and a control unit configured to control, when an operation of the button is accepted in a specific operation mode, the image capturing unit so that the image capturing unit performs shooting for a term that corresponds to a time period for which the operation is continued, and to control, in the specific operation mode, the image capturing unit so that the image capturing unit starts shooting in response to the touch operation on the touch panel, and ends the shooting when it is detected that the touch of the touch operation is released and another touch is performed.

In order to solve the aforementioned problems, the present invention provides an image capturing apparatus comprising: an image capturing unit; a button; a touch detecting unit configured to detect a touch operation on a touch panel; and a control unit configured to control, when the touch operation on the touch panel is accepted in a specific operation mode, the image capturing unit so that the image capturing unit performs shooting for a term that corresponds to a time period for which the touch operation is continued, and to control, in the specific operation mode, the image capturing unit so that the image capturing unit starts the shooting in response to an operation of the button, and ends the shooting in response to the button being released and then again being operated.

In order to solve the aforementioned problems, the present invention provides an image capturing apparatus comprising: an image capturing unit; a touch detecting unit configured to detect a touch operation on a touch panel; and a control unit configured to control so that shooting starts when it is detected that a touch on the touch panel is performed, the shooting is continued even after the touch is released when the release of the touch is detected before a predetermined time period from the start of the shooting elapses, and the shooting ends when it is detected that another touch was performed, and to control so that the shooting ends when it is detected that the touch is released after a predetermined time period from the start of the shooting elapses.

In order to solve the aforementioned problems, the present invention provides a control method of an image capturing apparatus having an image capturing unit, a button, and a touch detecting unit configured to detect a touch operation on a touch panel, the method comprising: a step of controlling, when an operation of the button is accepted in a specific operation mode, the image capturing unit so that the image capturing unit performs shooting for a term that corresponds to a time period for which the operation is continued, and controlling, in the specific operation mode, the image capturing unit so that the image capturing unit starts shooting in response to the touch operation on the touch panel, and ends the shooting when it is detected that the touch of the touch operation is removed and another touch is performed. In order to solve the aforementioned problems, the present invention provides a control method of an image capturing apparatus having an image capturing unit, a button, and a touch detecting unit configured to detect a touch operation on a touch panel, the method comprising: a step of controlling, when the touch operation on the touch panel is accepted in a specific operation mode, the image capturing unit so that the image capturing unit performs shooting for a term that corresponds to a time period for which the touch operation is continued, and controlling, in the specific operation mode, the image capturing unit so that the image capturing unit starts the shooting in response to an operation of the button, and ends the shooting in response to the button being released and then again being operated.

In order to solve the aforementioned problems, the present invention provides a control method of an image capturing apparatus having an image capturing unit, a button, and a touch detecting unit configured to detect a touch operation on a touch panel, the method comprising: a step of controlling so that shooting starts when it is detected that a touch on the touch panel is performed, the shooting is continued even after the touch is released when the release of the touch is detected before a predetermined time period from the start of the shooting elapses, and the shooting ends when it is detected that another touch was performed, and controlling so that the shooting ends when it is detected that the touch is released after a predetermined time period from the start of the shooting elapses.

According to the present invention, it is possible to easily switch, in accordance with a difference between the operation methods in the same operation mode without switching the operation mode, between a shooting such as BULB shooting that corresponds to an operation time period and a shooting such as TIME shooting in which the start and the end of shooting are independently instructed.

Further features of the present invention will become apparent from the following description of exemplary embodiments (with reference to the attached drawings).

### BRIEF DESCRIPTION OF THE DRAWINGS

FIG. 1A is an external view illustrating a front side of an image capturing apparatus according to an embodiment of the present invention.

FIG. 1B is an external view illustrating a rear side of the image capturing apparatus according to the embodiment of the present invention.

FIG. 2 is block diagram illustrating a configuration of the image capturing apparatus of the present embodiment.

FIG. 3 is a diagram illustrating an example of a live view display screen.

FIG. 4 is a flowchart illustrating shutter speed change processing.

FIG. 5 is a flowchart illustrating operations in a shooting mode.

FIG. 6 is a flowchart illustrating operations in BULB shooting.

FIG. 7 is a flowchart illustrating operations in TIME shooting.

### DESCRIPTION OF THE EMBODIMENTS

The following is a detailed description of embodiments for implementing the present invention with reference to the attached drawings.

### Embodiment 1

An embodiment will now be described in which an image capturing apparatus according to the present invention is realized by a single-lens reflex camera with interchangeable lenses (hereinafter referred to as a camera).

Apparatus Configuration

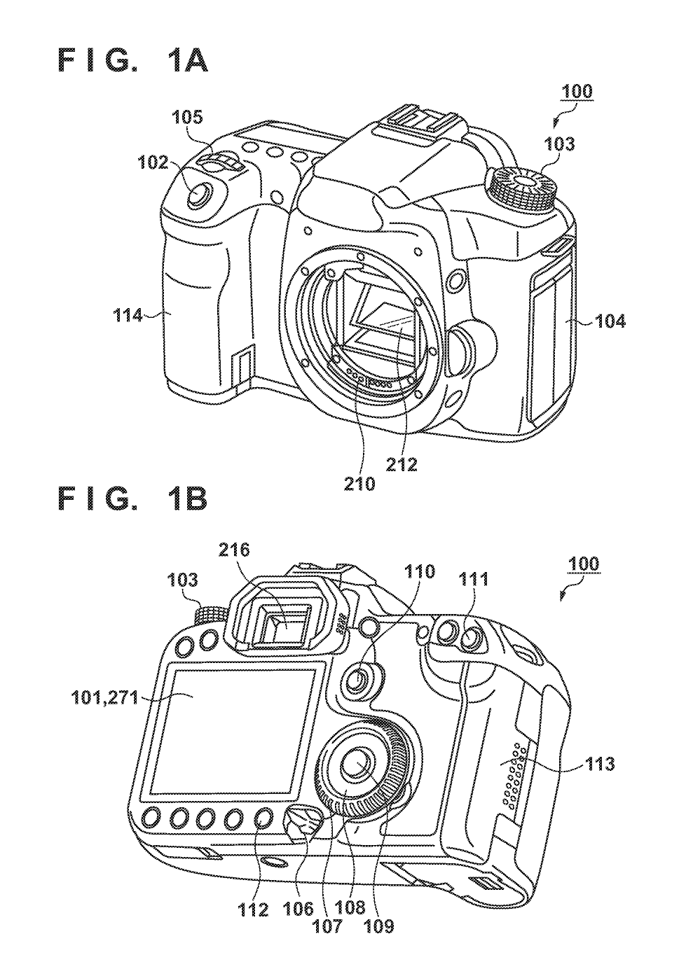

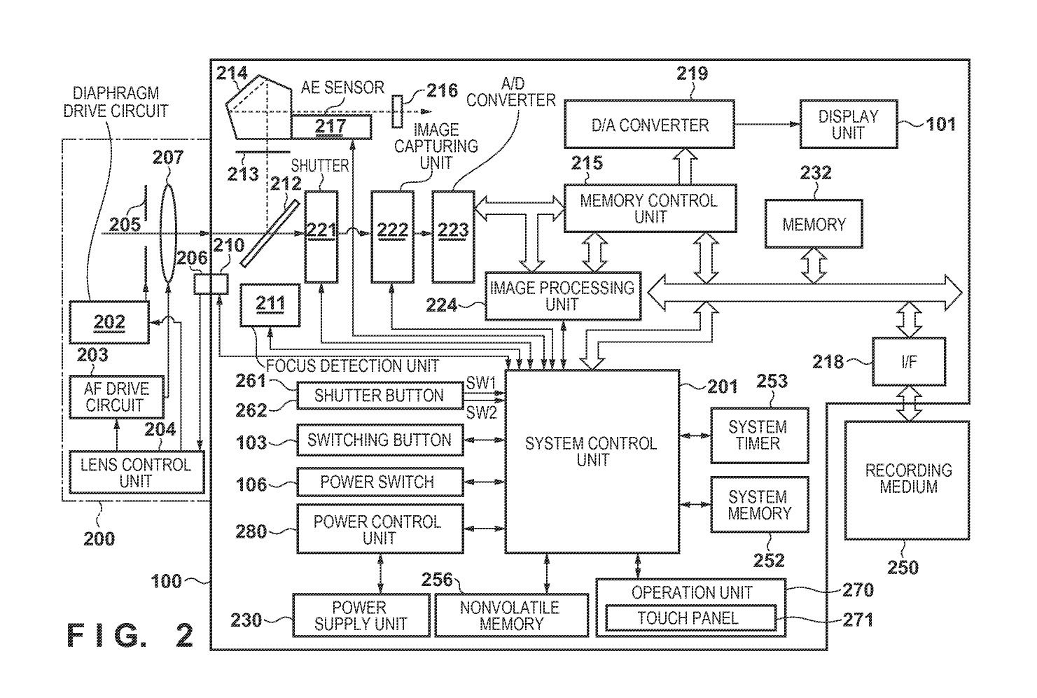

A configuration and functionality of the image capturing apparatus of the embodiments of the present invention will now be described with reference to FIGS. 1A, 1B, and 2.

In FIGS. 1A and 1B, a display unit 101 is a display device such as an LCD for displaying images and various types of information. A shutter button 102 is an operation member for instructing shooting. A mode switching button 103 is a dial operation member for switching between various modes. A terminal cover 104 is a cover member that protects a connector (not shown) for connecting an external device to a camera 100 via a cable such as a USB. A main electronic dial 105 is a rotational operation member that is included among operation units 270, which will be described later with reference to FIG. 2. By rotating this main electronic dial 105, it is possible to change setting values such as shutter speed and F-number. A power switch 106 is an operation member for turning the camera 1000N or OFF. A sub electronic dial 107 is also a rotational operation member that is included among the operation units 270, which will be described later with reference to FIG. 2, and can be used for shifting a selection border, and browsing images, for example. An arrow key 108 is a movable instructing member that is also included among the operation units 270, which will be described later with reference to FIG. 2, and pressing any of its upper, lower, left, and right portions makes it possible to perform an operation that corresponds to the pressed portion. A SET button 109, which is a push button also included among the operation units 270, which will be described later with reference to FIG. 2, is mainly used for selection of options. A live view button 110, which is also a push button included among the operation units 270, which will be described later with reference to FIG. 2, is used for switching a live view ON or OFF (hereinafter referred to as LV) display in a still image shooting mode and for instructing the start and the end of the moving image shooting (recording) in a moving image shooting mode. A zooming button 111, which is also a push button included among the operation units 270, which will be described later with reference to FIG. 2, is an operation member configured to switch a zooming mode ON or OFF in the live view display and to change the zooming ratio in the zooming mode. The zooming button 111 functions as a zooming button for zooming a reproduced image in a reproduction mode and increasing the zooming ratio. A reproduction button 112, which is also a push button included among the operation units 270, which will be described later with reference to FIG. 2, is an operation member for switching between a shooting mode and a reproduction mode. By pushing the reproduction button 112 in the shooting mode, it is possible to transit to the reproduction mode and to display, on the display unit 101, the latest of the images recorded on a recording medium 250 of FIG. 2.

In response to an instruction of a system control unit 201 shown in FIG. 2, a quick return mirror 212 is driven to an up position (exposure position) or a down position (live view position) by an actuator (not shown). A communication terminal 210 is an electrical contact through which the camera 100 communicates with a lens unit 200 (FIG. 2). A viewfinder 216 is an optical member through which a user looks and observes a focusing screen 213 (FIG. 2) to confirm the focal point and the composition of an optical image of an object that was loaded via the lens unit 200. A cover 113 is a member that opens and closes a slot so that the recording medium 250 can be inserted into and removed from the camera 100. A grip portion 114 has a shape that makes it easy for a user to grip the camera 100 with the right hand.

FIG. 2 illustrates an internal configuration of the camera 100 of the present embodiment.

In FIG. 2, the lens unit 200 provided with a shooting lens 207 can be attached to and removed from the camera 100. Although the shooting lens 207 is ordinarily constituted by a plurality of lenses, only one lens is illustrated for the sake of simplicity. A communication terminal 206 is an electrical contact through which the lens unit 200 communicates with the camera 100. The communication terminal 210 is an electrical contact through which the camera 100 communicates with lens unit 200. The lens unit 200 communicates with the system control unit 201 via the communication terminal 206. A lens control unit 204, which is included in the lens unit 200, controls a diaphragm drive circuit 202 so as to drive a diaphragm 205, as well as an AF drive circuit 203 so as to displace the position of the lens 207, thereby adjusting the focus of the lens unit 200.

An AE sensor 217 measures the luminance of an object that was loaded via the lens unit 200. A focus detection unit 211 outputs a defocus amount to the system control unit 201, and the system control unit 201 communicates with the lens unit 200 depending on the defocus amount, so as to perform AF control by phase difference detection.

When exposing, displaying a live view, and shooting a moving image, the quick return mirror (hereinafter referred to as “mirror”) 212 is driven, in response to an instruction from the system control unit 201, to an up position or a down position by an actuator (not shown). The mirror 212 switches a light bundle that was incident from the lens 207, to a viewfinder 216 or an image capturing unit 222. The mirror 212 is ordinarily urged to the down position so as to reflect the light bundle and guide the light bundle to a viewfinder 216, however, when exposing and displaying a live view, the mirror 212 is flipped upwards and retreats from the light bundle so as to guide the light bundle to the image capturing unit 222 (the up position). Further, the central part of the mirror 212 is half-mirrored so that part of the light bundle is transmitted and incident on the focus detection unit 211. By observing the focusing screen 213 via a pentaprism 214 and the viewfinder 216, a photographer can confirm the focal point and the composition of an optical image of an object that was loaded via the lens unit 200.

A shutter 221 is a focal plane shutter that can freely control, in accordance with an instruction of the system control unit 201, the exposure time in the image capturing unit 222. The image capturing unit 222 is an image sensor that is constituted by an image sensor such as a CCD and a CMOS that converts an optical image of an object into an electrical signal. An A/D converter 223 converts an analog signal that is output from the image capturing unit 222 into a digital signal, generating image data.

An image processing unit 224 performs resizing processing, such as predetermined pixel interpolation and reduction, and color conversion processing, with respect to data from the A/D converter 223 or data from a memory control unit 215. Further, the image processing unit 224 performs predetermined calculation processing using the captured image data, and the system control unit 201 performs exposure control and distance measuring control based on the calculation results. Thus, AF (Automatic Focus) processing, AE (Automatic Exposure) processing, and EF (flash pre-emission) processing of TTL (Through the Lens) type are performed. Furthermore, the image processing unit 224 performs predetermined calculation processing using the captured image data, and AWB (Automatic White Balance) processing of TTL type is performed on the basis of the calculation results.

The data from the A/D converter 223 is directly written into a memory 232 via both the image processing unit 224 and the memory control unit 215 or via the memory control unit 215. The memory 232 stores the image data obtained from the image capturing unit 222 and the A/D converter 223, and image display data to be displayed on the display unit 101. The memory 232 has a storage capacity that is sufficient for storing a predetermined number of still images as well as moving images and audio for a predetermined time period. The memory 232 also functions as a memory for image display (video memory). A D/A converter 219 converts the image display data stored in the memory 232 into an analog signal and applies the display unit 101 with the analog signal. The image display data that was written into the memory 232 is displayed by the display unit 101 via the D/A converter 219. The display unit 101 performs, on a display device such as an LCD, display in accordance with the analog signal from the D/A converter 219. In this manner, the digital signals stored in the memory 232 are converted into analog signals, and the analog signals are successively transmitted to the display unit 101 so as to be displayed thereon, making it possible to realize an electronic view finder (EVF) functionality and to perform through image display (live view display).

A nonvolatile memory 256 is, for example, an EEPROM, which is electrically erasable and recordable. In the nonvolatile memory 256, constants and programs, for example, for operating the system control unit 201 are stored. In this context, “programs” may refer to programs for executing various types of flowcharts that will be described later.

The system control unit 201 is a calculation processing device for overall controlling the entire camera 100, and realizes, by executing the programs stored in the nonvolatile memory 256, the procedures of the flowcharts that will be described later. The system memory 252 is, for example, a RAM and used also as a work memory where constants and variables for operating the system control unit 201, and the programs read out from the nonvolatile memory 256 are expanded. The system control unit 201 controls the memory 232, the D/A converter 219, the display unit 101, and the like, so as to perform display control. A system timer 253 is a timer circuit for measuring time periods for various types of controls and the time of an integrated clock.

A mode switching button 103, a first shutter switch 261, a second shutter switch 262, and the operation units 270 are operation members for inputting various types of instructions into the system control unit 201.

The mode switching button 103 switches the operation mode of the system control unit 201 to any of a still image recording mode, a moving image recording mode, and a reproduction mode. The still image recording mode includes an automatic shooting mode, an automatic scene determination mode, a manual mode, a diaphragm priority mode (Av mode), a shutter speed priority mode (Tv mode), various types of scene modes in which different settings are configured for individual shooting scenes, a program AE mode, a custom mode, and the like.

Using the mode switching button 103, the mode is directly switched to any of the plurality of modes included in the still image recording mode. Alternatively, it is also possible to switch, using the mode switching button 103, to the still image recording mode and then to switch, using another operation member, to any of the plurality of modes included in the still image shooting mode. Similarly, also the moving image shooting mode may include a plurality of modes.

While the shutter button 102 provided on the camera 100 is being operated, that is, pressed half-way (the shooting preparation instruction), the first shutter switch 261 is turned on and generates a first shutter switch signal SW1. Upon receiving the first shutter switch signal SW1, the system control unit 201 causes the image processing unit 224 to start the AF (Automatic Focus) processing, the AE (Automatic Exposure) processing, the AWB (Automatic White Balance) processing, the EF (flash pre-emission) processing and the like.

When the operation of the shutter button 102 is completed, that is, the shutter button 102 is pressed fully (the shooting instruction), the second shutter switch 262 is turned on and generates a second shutter switch signal SW2. Upon receiving the second shutter switch signal SW2, the system control unit 201 starts a series of shooting processing from reading out the signal from the image capturing unit 222 to writing of image data to the recording medium 250.

By selecting various functional icons displayed on the display unit 101, appropriate functions for each situation are assigned to the operation units 270, and the operation units 270 thus act as various function buttons (soft button). Examples of these function buttons include an end button, a back button, an image scrolling button, a jump button, a narrow-down button, an attribute change button. For example, a menu screen that enables various settings to be made is displayed on the display unit 101 by pressing a menu button. The user can make various settings intuitively by using the menu screen, which is displayed on the display unit 101, four-direction (up, down, left, right) buttons and a SET button.

The operation units 270 are input units that receive an operation of the user and notify the system control unit 201 thereof, and include at least the following operation members: The shutter button 102, the main electronic dial 105, the power switch 106, the sub electronic dial 107, the arrow key 108, the SET button 109, the LV button 110, the zooming button 111, and the reproduction button 112.

A power control unit 280 is constituted by, for example, a battery detection circuit, a DC-DC converter, a switch circuit for changing over the block to be supplied with power, and detects a battery has been inserted or not, the type of the battery, and the residual capacity thereof. Further, the power control unit 280 controls the DC-DC converter in accordance with the detection results and an instruction of the system control unit 201, and supplies a necessary voltage for a necessary length of time to each of the units including the recording medium 250.

A power supply unit 230 comprises a primary battery such as an alkaline battery or a lithium battery, a secondary battery such as an NiCd battery, an NiMH battery, or an Li battery, or an AC adaptor. The recording medium interface (I/F) 218 is for interfacing with the recording medium 250 such as the memory card or hard disk. The recording medium 250 is a recording medium such as a memory card for recording shot images, and constituted by a semiconductor memory, a magnetic disk, or the like.

Included among the operation units 270 is also a touch panel 271 as a touch detecting unit capable of detecting a touch operation on the display unit 101. The touch panel 271 and the display unit 101 can be constructed as a single integrated unit. For example, the touch panel 271 is constructed in such a manner that the transmittance of light will not interfere with the display presented by the display unit 101, and it is attached to the uppermost layer of the display face of the display unit 101. In addition, input coordinates on the touch panel 271 and display coordinates on the display unit 101 are correlated. As a result, a GUI can be constructed that makes it possible for the user to directly manipulate the screen displayed on the display unit 101. The system control unit 201 is capable of detecting the following operations performed by contacting the touch panel 271: touching of the panel 271 using a finger or pen (referred to as “touch-down” below); a state in which the touch panel 271 is in contact with a finger or pen (referred to as “touch-on” below); movement of a finger or pen while in contact with the touch panel 271 (referred to as “move” below); lifting of a finger or pen that has been in contact with the touch panel 271 (referred to as “touch-up” below); and a state in which the touch panel 271 is not being touched at all (referred to as “touch-off” below). These operations and position coordinates at which the touch panel 271 is being touched by the finger or pen are communicated to the system control unit 201 through an internal bus and, based upon the information thus communicated, the system control unit 201 determines what kind of operation was performed on the touch panel 271. As for “move”, the determination can be made also for every vertical component and horizontal component with regard to the direction of movement of the finger or pen, which is moved on the touch panel 271, based upon a change in the coordinate position. Further, it is assumed that a stroke has been made when “touch-up” is performed following a regular “move” after a “touch-down” on the touch panel 271. A very quick stroke action is referred to as a “flick”. A “flick” is an operation in which, with fingers in contact with the touch panel 271, the fingers are moved rapidly over a certain distance and then lifted. In other words, this is a rapid tracing operation in which the fingers are flicked across the surface of the touch panel 271. The system control unit 201 can determine that a “flick” has been performed when it detects such movement over a predetermined distance or greater and at a predetermined speed or greater and then detects “touch-up”. Further, the system control unit 201 can determine that “drag” has been performed if it detects movement over a predetermined distance or greater at a speed less than a predetermined speed. It should be noted that the touch panel 271 may employ a method that relies upon any of the following: resistive film, electrostatic capacitance, surface acoustic waves, infrared radiation, electromagnetic induction, image recognition and optical sensing.

Shutter Speed Change Processing

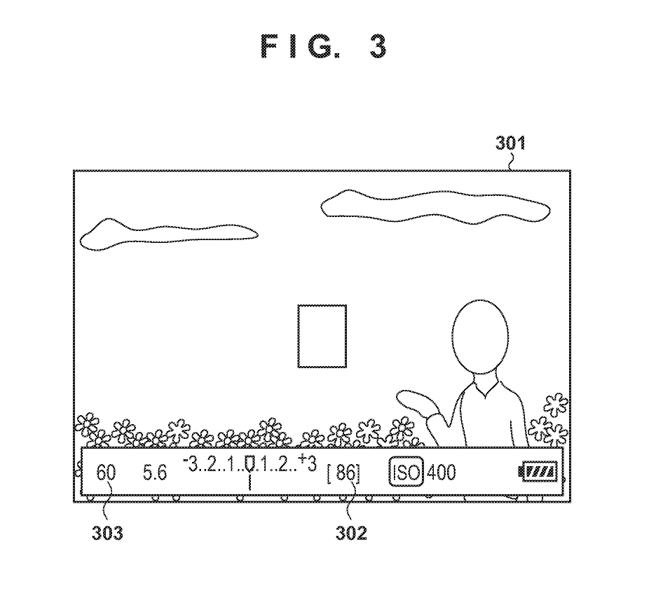

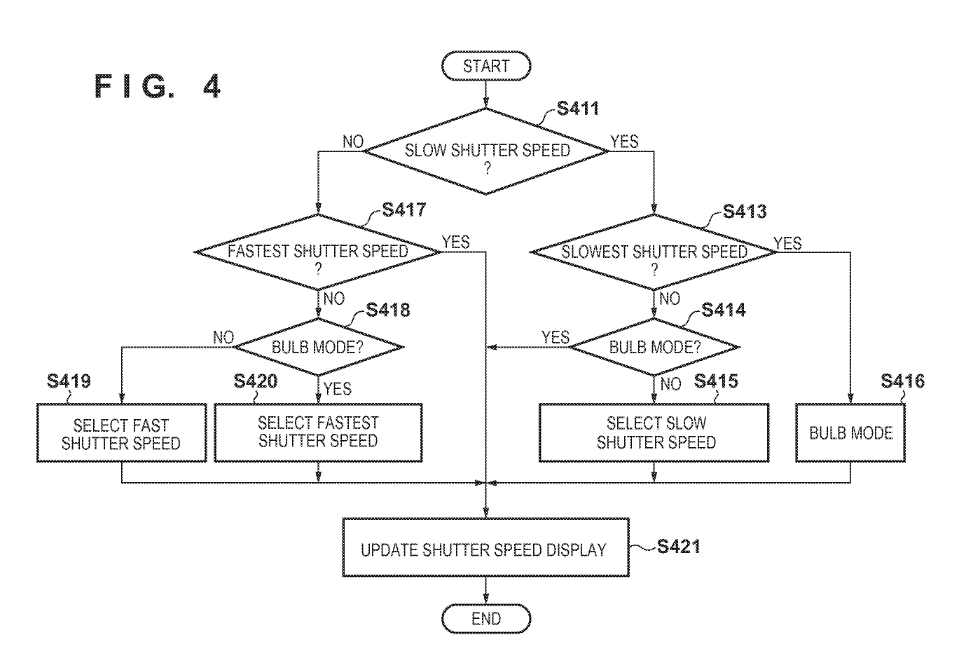

The following is a description of shutter speed change processing with reference to FIGS. 3 and 4.

FIG. 3 illustrates an example of a screen of the display unit 101 during the live view display. When the camera is turned on by the user, the system control unit 201 sets the display unit 101 to the state of “no display”, an “information display screen”, or a “through image display screen (LV display screen)”, in accordance with the settings at the time.

Reference numeral 301 denotes a live view display screen, in which a through image is displayed over the entire screen, and icons and characters that indicate setting items are arranged in a screen lower part 302.

Reference numeral 303 denotes a region where a shutter speed held in the system memory 252 is displayed.

FIG. 4 is a flowchart illustrating shutter speed change processing performed by the image capturing apparatus of the present embodiment, in which the user, for example, configures settings of the shutter speed using the main electronic dial 105, the touch panel 271, or the like. With respect to settings and change of the shutter speed in the Tv mode (a mode in which the shutter speed is designated by the user and an F-number is automatically set in accordance with the designated shutter speed) and the manual mode (a mode in which both the shutter speed and the F-number are designated by the user), it is possible to change setting values in accordance with the operation of the main electronic dial 105 while displaying the live view or without displaying the live view. Further, it is also possible to change setting values by a touch operation on the touch panel 271 while opening a setting screen through which various types of shooting conditions are set. That is, there are several operation members for setting and changing the shutter speed, but each operation member, when it is used, has two directions of a fast shutter speed side and a slow shutter speed side. For example, the main electronic dial 105 can be operated in a clockwise direction and in a counterclockwise direction. If a shutter speed setting operation member is operated in a situation in which the shutter speed can be set and changed, then the system control unit 201 starts the shutter speed change processing of FIG. 4. Note that the processing is implemented by expanding, in the system memory 252, a program stored in the nonvolatile memory 256 and causing the system control unit 201 to execute the program. Since this processing is performed in accordance with an operation amount of the operation member corresponding to the setting value for one level (for example, a rotational operation of the main electronic dial 105 corresponding to one click), when an amount for a single operation is greater or the operation is repeated, then the processing is repeated the number of times that corresponds to the operation amount.

Referring to FIG. 4, in step S411, the system control unit 201 determines whether the operation member is operated to the slow shutter speed side, and if it is determined that a change is made to the slow shutter speed side, the procedure advances to step S413 so as to set to the slow shutter speed, and otherwise, the procedure advances to step S417 so as to set to the fast shutter speed.

In step S413, the system control unit 201 determines whether or not the shutter speed held in the system memory 252 is the slowest shutter speed that can be set, and if it is determined that the shutter speed is the slowest shutter speed, the procedure advances to step S416, and otherwise, the procedure advances to step S414. In the description here, it is assumed that the slowest shutter speed of the camera is 30 seconds.

In step S416, the system control unit 201 sets the shutter speed that is held in the system memory 252 to a specific value that indicates a long exposure shooting mode for an indefinite slow shutter speed (hereinafter referred to as a “BULB mode”), in which long exposure shooting is possible with an indefinite slow shutter speed. In the description here, it is assumed that the specific value that indicates the BULB mode of the camera is 60 seconds.

In step S414, the system control unit 201 determines whether or not the shutter speed is the specific value (60 seconds) that indicates the BULB mode, and if it is determined that the BULB mode is indicated, the procedure advances to step S421, and otherwise, the procedure advances to step S415.

In step S415, the system control unit 201 changes the shutter speed held in the system memory 252 to the slow shutter speed side by one level.

In step S417, the system control unit 201 determines whether or not the shutter speed held in the system memory 252 is the fastest shutter speed, and if it is determined that the shutter speed is the fastest shutter speed, the procedure advances to step S421, and otherwise, the procedure advances to step S418. In the description here, it is assumed that the fastest shutter speed of the camera is 1/4000 seconds. In step S418, the system control unit 201 determines whether or not the shutter speed is a specific value (60 seconds) indicating the BULB mode, and if it is determined that the BULB mode is indicated, the procedure advances to step S420, and otherwise, the procedure advances to step S419.

In step S419, the system control unit 201 changes the shutter speed held in the system memory 252 to the fast shutter speed side by one level.

In step S420, the system control unit 201 sets the shutter speed held in the system memory 252 to 30 seconds, which is the slowest shutter speed, and the procedure advances to step S421.

In step S421, the system control unit 201 updates the value of the shutter speed display region 303 in FIG. 3. If the shutter speed is the specific value (60 seconds) that indicates the BULB mode, the characters “BULB” are displayed, and otherwise, the shutter speed is displayed in numerical values.

Shooting Processing

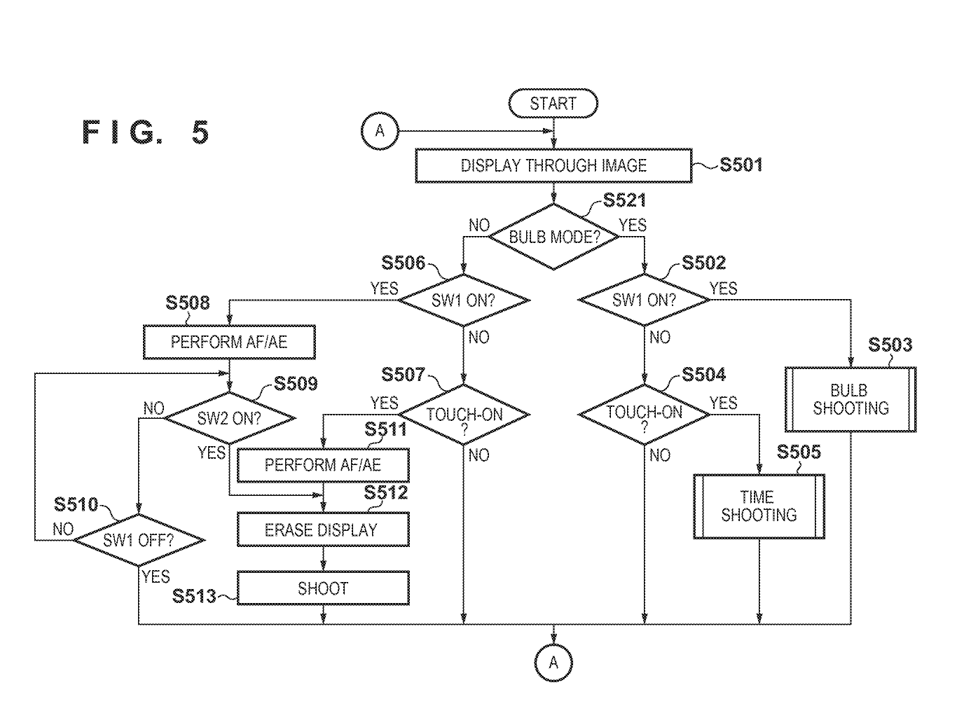

An operation in the shooting mode of the present embodiment will be described with reference to FIG. 5. This processing is implemented by expanding, in the system memory 252, a program stored in the nonvolatile memory 256 and causing the system control unit 201 to execute the program. Note that the shooting mode is mutually exclusive with respect to a camera setting change screen.

Referring to FIG. 5, in step S501, the system control unit 201 updates the through image that is displayed on the LV display screen.

In step S521, the system control unit 201 determines whether or not the shutter speed is a specific value (60 seconds) that indicates the BULB mode, and if it is determined that the BULB mode is indicated, the procedure advances to step S502, and otherwise, the procedure advances to step S506.

In step S506, the system control unit 201 determines the state of the first shutter switch 261, and if it is determined that it is in the ON state, the procedure advances to step S508, whereas if it is determined that it is in the OFF state, the procedure advances to step S507.

In step S508, the system control unit 201 performs the well-known AE and AF.

In step S509, the system control unit 201 determines the state of the second shutter switch 262, and if it is determined that it is in the ON state, the procedure advances to step S512, whereas if it is determined that it is in the OFF state, the procedure advances to step S510.

In step S510, the system control unit 201 determines the state of the first shutter switch 261, and if it is determined that it is in the ON state, the procedure advances to step S509, whereas if it is determined that it is in the OFF state, the procedure advances to step S501.

In step S512, the system control unit 201 turns off the LV display screen of the display unit 101.

In step S513, the system control unit 201 performs shooting of a still image under the conditions that have been set in advance in the system, generating still image data.

In step S507, the system control unit 201 determines the state of the touch panel, and if it is determined that the touch panel is in the “touch-on” state, the procedure advances to step S511, whereas if it is determined that the touch panel is in the “touch-off” state, the procedure returns to step S501.

In step S511, as with step S508, the system control unit 201 performs the AE and the AF, and subsequently the procedures of steps S512 and S513, generating still image data.

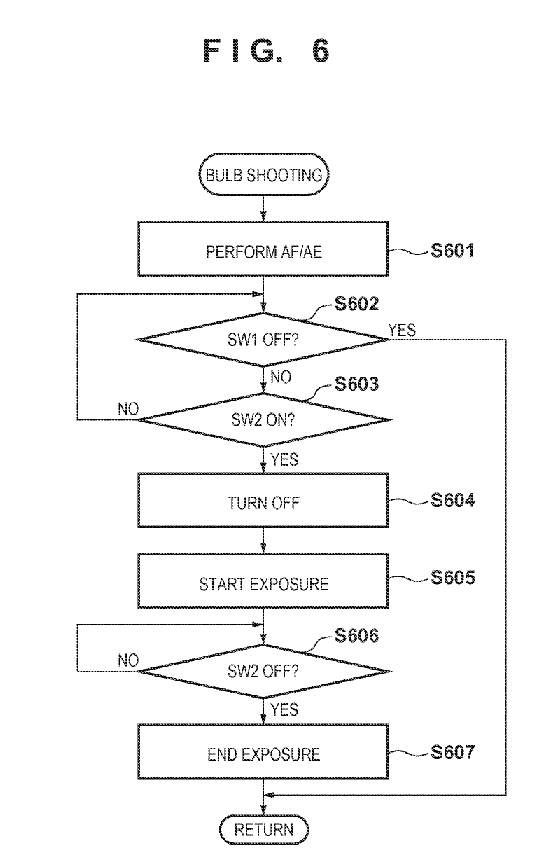

On the other hand, in step S502, the system control unit 201 determines the state of the first shutter switch 261, and if it is determined that it is in the OFF state, the procedure advances to step S504, whereas if it is determined that it is in the ON state, the procedure advances to step S503 where BULB shooting is performed. The detail of BULB shooting will be described later with reference to FIG. 6.

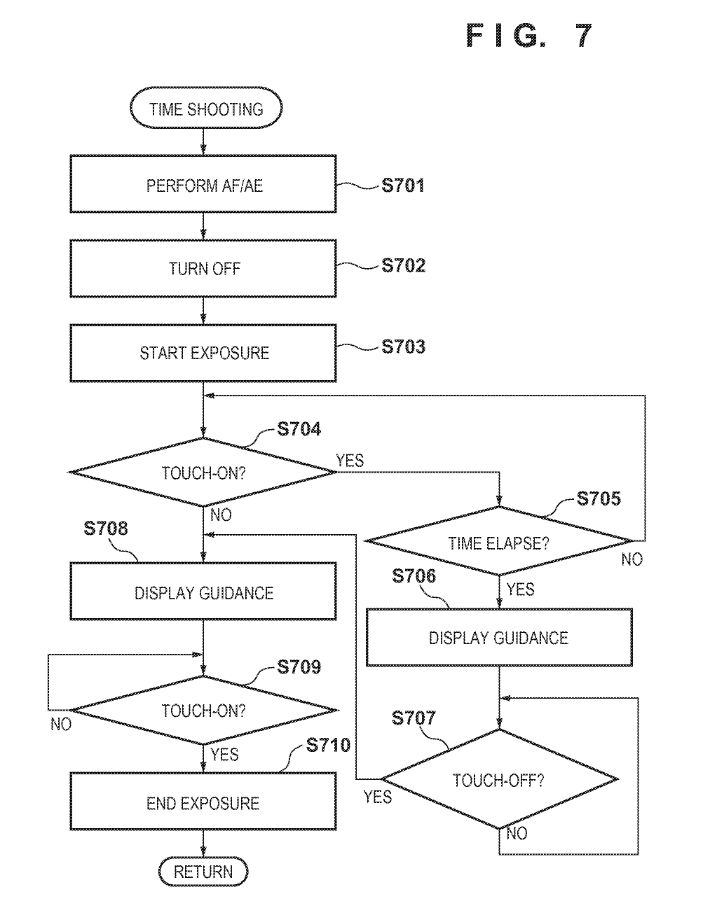

In step S504, the system control unit 201 determines the state of the touch panel, and if it is determined that the touch panel is in the “touch-off” state, the procedure returns to step S501, whereas if it is determined that the touch panel is in the “touch-on” state, the procedure advances to step S505 where TIME shooting is performed. The detail of TIME shooting will be described later with reference to FIG. 7. Further, a configuration is also possible in which shooting by the touch panel operation is only performed when a specific region is touched.

BULB Shooting

The BULB shooting operation performed in step S503 in FIG. 5 will be described with reference to FIG. 6.

Referring to FIG. 6, in step S601, the system control unit 201 performs the AE and the AF.

In step S602, the system control unit 201 determines the state of the first shutter switch 261, and if it is determined that it is in the ON state, the procedure advances to step S603, whereas if it is determined that it is in the OFF state, the BULB shooting ends.

In step S603, the system control unit 201 determines the state of the second shutter switch 262, and if it is determined that it is in the ON state, the procedure advances to step S604, whereas if it is determined that it is in the OFF state, the procedure returns to step S602.

In step S604, the system control unit 201 turns off the LV display screen of the display unit 101.

In step S605, the system control unit 201 starts exposure to the image capturing unit 222 under the shooting conditions that have been set for the system.

In step S606, the system control unit 201 waits until the state of the second shutter switch 262 changes from ON to OFF, and if it turns into the OFF state, the procedure advances to step S607.

In step S607, the system control unit 201 ends the exposure to the image capturing unit 222, and generates still image data in the image processing unit 224.

Note that, during BULB shooting (during exposure), no operation on the touch panel is accepted, in order to prevent an erroneous operation.

TIME Shooting

TIME shooting operation performed in step S505 in FIG. 5 will be described with reference to FIG. 7.

Referring to FIG. 7, in step S701, the system control unit 201 performs the AE and the AF.

In step S702, the system control unit 201 turns off the LV display screen of the display unit 101.

In step S703, the system control unit 201 starts exposure to the image capturing unit 222 under the shooting conditions that have been set for the system. Further, the system control unit 201 starts a touch-on timer.

In step S704, the system control unit 201 determines the state of the touch panel, and if it is determined that the touch panel is in the “touch-on” state, the procedure advances to step S705, whereas if it is determined that the touch panel is in the “touch-off” state, the procedure advances to step S708.

In step S705, the system control unit 201 determines whether or not the touch-on timer exceeds a prescribed guidance display time Tg that has been set in advance, and if the prescribed guidance display time Tg is exceeded, the procedure advances to step S706, whereas if it is not exceeded, the procedure advances to step S704.

In step S706, the system control unit 201 displays, on the display unit 101, a guidance “TIME shooting has started”. This allows the user to recognize that TIME shooting, instead of BULB shooting, is being performed, making it possible for the user to properly use each of BULB shooting and TIME shooting without confusing them. That is, the user can recognize that his finger keeping currently in touch with the screen can be removed, without erroneously recognizing that BULB shooting is being performed and continuing the touch operation. Further, by displaying the guidance after the state shifts to “touch-on” and Tg elapses, no guidance is presented to the user who has recognized that TIME shooting is being performed and has removed his finger immediately after touching, whereas the guidance is presented only to the user who continues to touch until Tg elapses and is liable to erroneously recognize that BULB shooting is being performed.

In step S707, the system control unit 201 waits until the state of the touch panel turns from the “touch-on” state to the “touch-off” state, and if it turns into the “touch-off” state, the procedure advances to step S708.

In step S708, the system control unit 201 displays, on the display unit 101, a guidance “TIME shooting will end with the next touch”. Next, in step S709, the system control unit 201 waits until the state of the touch panel again shifts from the “touch-off” state to the “touch-on” state, and if it shifts to the “touch-on” state, the procedure advances to step S710.

In step S710, the exposure to the image capturing unit 222 ends and still image data is generated by the image processing unit 224.

Note that during TIME shooting (during exposure), no operation on the shutter button 102 is accepted, in order to prevent an erroneous operation. Although the present embodiment has been described for the case that exposure starts with “touch-on”, it is also possible that exposure starts with “touch-up”. In this case, exposure starts with “touch-up” and ends with “touch-down”.

As has been described above, according to the present embodiment, in the long exposure shooting mode for an indefinite slow shutter speed, BULB shooting is performed with the shutter button operation and TIME shooting is performed with the touch panel operation, so that it is possible to easily switch between BULB shooting and TIME shooting, achieving a reduction in camera shake.

Modifications

It is also possible to modify part of the above-described procedure of TIME shooting so that the following procedure is performed. This makes it possible to prevent TIME shooting from inadvertently ending.

That is, in step S708 in FIG. 7, instead of a guidance being displayed, a TIME shooting end button is displayed, which is a button in which “TIME shooting end” is enclosed by a rectangular frame. And, in step S709, if the coordinates of the “touch-on” position and the touch position are within a range of the TIME shooting end button region, the procedure advances to step S710, whereas if the coordinates of the “touch-off” position and the touch position are outside the TIME shooting end button region, the procedure advances to step S709.

With this configuration, it is possible to prevent the situation in which the user's inadvertent touch unintentionally ends the exposure.

It is also possible that TIME shooting ends with the shutter button 102 as described below.

That is, in step S709, if “touch-on” is detected or the first shutter switch 261 is in the ON state, then the procedure advances to step S710, and if “touch-off” is detected and the first shutter switch 261 is in the OFF state, the procedure returns to step S709.

With this configuration, it is possible to end the touch shooting by using both “touch-off” and the shutter button.

Further, another configuration is also possible in which the touch-on timer switches between BULB shooting and TIME shooting.

That is, in step S705, it is determined whether or not the touch-on timer exceeds the prescribed BULB shooting time Tb that has been set in advance, and if the BULB shooting time Tb is exceeded, the procedure advances to step S709, whereas if it is not exceeded, the procedure advances to step S707. And, in step S707, unless the state of the touch panel does not change from the “touch-on” state to the “touch-off” state, the procedure advances to step S704.

With this configuration, it is possible to switch between TIME shooting and BULB shooting, in such a manner that BULB shooting is performed when a time period for which “touch-on” is performed exceeds a predetermined time Tb at the time of the shooting start, and TIME shooting is performed when “touch-off” is performed before the time period exceeds Tb. This is because an operation for continuously keeping in touch for a long time is considered as an operation of BULB shooting in which it is expected to perform exposure according to the time period for which the screen is touched, and an operation for keeping in touch for a short time is considered as an operation that is to instruct the start of TIME shooting. By performing the different touch operations in the same shooting mode, it is possible to use BULB shooting and TIME shooting intuitively and properly.

Note that it is also possible to perform TIME shooting using the shutter button operation, and BULB shooting using the touch panel operation.

Although the above-described embodiments have described examples in which BULB shooting and TIME shooting, which both have the slow shutter speed of long exposure time, are properly used depending on whether the button operation or the touch operation is performed, the present invention is applicable without being limited to the slow shutter speed of long exposure time, if performing continuous shooting.

An example will be described in which the present invention is applied to continuous shooting. In a specific shooting mode, the continuous shooting starts in response to the shutter button operation (turning on of the second shutter switch 262). As long as the shutter button operation is continued (as long as the second shutter switch 262 is in the ON state), the continuous shooting is continued (repeated shooting is automatically performed). And, if the shutter button operation ends (if the second shutter switch 262 is turned off), then the continuous shooting ends. On the other hand, the continuous shooting starts in response to the detection of “touch-on” on the touch panel in the above-mentioned specific shooting mode. And, even if the “touch-on” state shifts to the “touch-off”state (even if the touch on the touch panel is once removed), the continuous shooting is continued. If, after the “touch-off” state, the state again shifts to the “touch-on” state (if again the touch operation on the touch panel is performed), the continuous shooting ends.

Also, another case will be described in which the present invention is applied to the moving image shooting. In a specific shooting mode, the moving image shooting (moving image recording) starts in response to the shutter button operation (turning on of the second shutter switch 262). As long as the shutter button operation is continued (as long as the second shutter switch 262 is in the ON state), the moving image shooting (moving image recording) is continued. And, if the shutter button operation ends (if the second shutter switch 262 is turned off), then the moving image shooting (moving image recording) ends. On the other hand, the moving image shooting (moving image recording) starts in response to the detection of “touch-on” on the touch panel in the above-mentioned specific shooting mode. And, even if the “touch-on” state shifts to the “touch-off” state (even if the touch on the touch panel is once removed), the moving image shooting (moving image recording) is continued. If, after the “touch-off” state, the state again shifts to the “touch-on” state (if again the touch operation on the touch panel is performed), the moving image shooting (moving image recording) ends.

Regarding the above-described continuous shooting and the moving image shooting, it is also possible to configure the control of the shutter button operation and the touch panel operation the other way round relative to the above-described example. However, it is effective to assign the touch panel operation to shooting that necessitates reoperation for ending the shooting since a reduction in camera shake can be achieved.

Note that the control with the system control unit 201 may be carried out with a single hardware component or with a plurality of hardware components sharing the processing load.

Although the present invention has been described in detail on the basis of its suitable embodiments, the present invention is not limited to these specific embodiments, and includes various aspects without departing from the scope of the summary of the present invention. Further, the above-described embodiments show merely examples of the present invention, and can be suitably combined.

Although the above-described embodiments has been described with examples in which the present invention is applied to an image capturing apparatus, the present invention is not limited to these examples and the present invention is applicable to any apparatus in which, for example, BULB shooting and TIME shooting can be switched by an operation member. That is, the present invention is also applicable to cellular phone units, game consoles, and the like that have the camera functionality.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2012-066108, filed Mar. 22, 2012 and 2013-029437, filed Feb. 18, 2013, which are hereby incorporated by reference herein in their entirety.

What is claimed is:

1. An image capturing apparatus comprising:
an image capturing unit;
a button;
a touch detecting unit configured to detect a touch operation on a touch panel; and
a control unit configured to control, when an operation of the button is accepted in a specific operation mode, the image capturing unit so that the image capturing unit performs shooting for a term that corresponds to a time period for which the operation is continued, and
to control, in the specific operation mode, the image capturing unit so that the image capturing unit starts shooting in response to the touch operation on the touch panel, and ends the shooting when it is detected that the touch of the touch operation is released and another touch is performed.

2. The apparatus according to claim 1,
wherein the control unit controls so that the touch operation is not accepted during the shooting that was started in response to the operation of the button.

3. The apparatus according to claim 1,
wherein the control unit controls so that the operation of the button is not accepted when the shooting was started in response to the touch operation being detected.

4. The apparatus according to claim 1,
wherein the control unit controls the image capturing unit so that the shooting ends when the operation of the button is detected, even in the case where the shooting was started in response to the touch operation being detected.

5. The apparatus according to claim 1,
wherein the control unit is configured, when the shooting was started in response to the touch operation being detected, to display a guidance indicating the start of the shooting when a predetermined time period elapses while the touch operation is being detected, and to display a guidance indicating that the shooting will end with the next touch when it is determined that the touch of the touch operation is released during the shooting.

6. The apparatus according to claim 1,
wherein the control unit is configured, when the shooting was started in response to the touch operation being detected, to display a soft button for ending the shooting, and to end the shooting when it is detected that another touch is performed and a position of the other touch is within a region of the soft button.

7. The apparatus according to claim 1,
wherein the control unit is configured, when the shooting was started in response to the touch operation being detected, to end the shooting when a predetermined time period elapses while the touch operation is being detected and when it is detected that the touch was released, and
to end the shooting when it is detected that the touch was released before the predetermined time period elapses and that another touch was performed.

8. The apparatus according to claim 1,
wherein the shooting is exposure.

9. The apparatus according to claim 1,
wherein the shooting is a moving image recording.

10. The apparatus according to claim 1,
wherein the shooting is continuous shooting.

11. An image capturing apparatus comprising:
an image capturing unit;
a button;
a touch detecting unit configured to detect a touch operation on a touch panel; and
a control unit configured to control, when the touch operation on the touch panel is accepted in a specific operation mode, the image capturing unit so that the image capturing unit performs shooting for a term that corresponds to a time period for which the touch operation is continued, and
to control, in the specific operation mode, the image capturing unit so that the image capturing unit starts the shooting in response to an operation of the button, and ends the shooting in response to the button being released and then again being operated.

12. An image capturing apparatus comprising:
an image capturing unit;
a touch detecting unit configured to detect a touch operation on a touch panel; and
a control unit configured to control so that shooting starts when it is detected that a touch on the touch panel is performed, the shooting is continued even after the touch is released when the release of the touch is detected before a predetermined time period from the start of the shooting elapses, and the shooting ends when it is detected that another touch was performed, and
to control so that the shooting ends when it is detected that the touch is released after a predetermined time period from the start of the shooting elapses.

13. A control method of an image capturing apparatus having an image capturing unit, a button, and a touch detecting unit configured to detect a touch operation on a touch panel, the method comprising:
a step of controlling, when an operation of the button is accepted in a specific operation mode, the image capturing unit so that the image capturing unit performs shooting for a term that corresponds to a time period for which the operation is continued, and
controlling, in the specific operation mode, the image capturing unit so that the image capturing unit starts shooting in response to the touch operation on the touch panel, and ends the shooting when it is detected that the touch of the touch operation is removed and another touch is performed.

14. A control method of an image capturing apparatus having an image capturing unit, a button, and a touch detecting unit configured to detect a touch operation on a touch panel, the method comprising:
a step of controlling, when the touch operation on the touch panel is accepted in a specific operation mode, the image capturing unit so that the image capturing unit performs shooting for a term that corresponds to a time period for which the touch operation is continued, and
controlling, in the specific operation mode, the image capturing unit so that the image capturing unit starts the shooting in response to an operation of the button, and ends the shooting in response to the button being released and then again being operated.

15. A control method of an image capturing apparatus having an image capturing unit, a button, and a touch detecting unit configured to detect a touch operation on a touch panel, the method comprising:
a step of controlling so that shooting starts when it is detected that a touch on the touch panel is performed, the shooting is continued even after the touch is released when the release of the touch is detected before a predetermined time period from the start of the shooting elapses, and the shooting ends when it is detected that another touch was performed, and
controlling so that the shooting ends when it is detected that the touch is released after a predetermined time period from the start of the shooting elapses.

16. A non-transitory computer-readable storage medium storing a program for causing a computer to execute the control method according to claim 13.

17. A non-transitory computer-readable storage medium storing a program for causing a computer to execute the control method according to claim 14.

18. A non-transitory computer-readable storage medium storing a program for causing a computer to execute the control method according to claim 15.
